(19) United States
(12) Patent Application Publication
(10) Pub. No.: US 2003/0207672 A1
(43) Pub. Date: Nov. 6, 2003

(54) Wideband tuning circuit for low-voltage silicon process and method for generating a tuning frequency

(75) Inventors: Nam V. Dang, Chandler, AZ (US); Thomas G. Egan, Chandler, AZ (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/138,460

(22) Filed: May 3, 2002

(51) Int. Cl. H04B 1/18

(52) U.S. Cl. 455/150.1; 455/151.3; 455/154.1

(57) ABSTRACT

A wideband tuning circuit suitable for a low-voltage silicon process includes a plurality of frequency band modules for generating a frequency within a particular frequency band of the tuning range. Each frequency band module includes a tuning sensitivity controller responsive to a tuning sensitivity control signal, a sub-band tuning network responsive to one of the frequency band module control signals, a resonator inductor, and a negative resistance generator coupled to the inductor to offset resistance of the inductor. A frequency band module control signal causes the sub-band tuning network to select a sub-band within the frequency band of one of the frequency band module, and a tuning sensitivity control signal causes the tuning sensitivity controller to control the output frequency of the frequency band module within a selected sub-band. A multiplexer selectively couples the output frequency from one of the frequency band modules in response to a band select signal.

### FIELD OF THE INVENTION

The invention pertains to frequency synthesizers, and in particular, to wideband tuning circuits which may be suitable for television systems and cable modems employing dual conversion receivers.

### BACKGROUND OF THE INVENTION

Dual conversion receivers employed in television receivers, cable and community television (CATV) receivers and cable modems up-convert a received signal to a much higher frequency, filter the signal and down-convert the signal to an IF frequency. This process improves received signal quality by eliminating image signals. Up-converting requires generating an accurate tuning frequency within a wide tuning frequency range. Conventional synthesizing methods use a relatively high-voltage (e.g., 33 volts), high-capacitance ratio varactor as the tuning element in a resonator circuit.

One problem with generating a tuning frequency using conventional methods is that high-voltage, high-capacitance ratio varactors are not compatible with modem low voltage semiconductor processes, such as CMOS. This prevents the fabrication of a wideband tuning circuit on a semiconductor chip. Another problem with generating a wideband tuning frequency using conventional methods is that high-voltage, high-capacitance ratio varactors exhibit severe non-linearities at both ends of their tuning curves. This makes it difficult to keep resonator sensitivity and phase noise constant which reduces the phase margin causing the phase-locked-loop to easily drop out of lock. Another problem with generating a wideband tuning frequency using conventional methods is that a separate power supply is often required for the high-voltage, high-capacitance ratio varactors. This increases cost and requiring additional space.

Thus, what is needed is an improved wideband tuning circuit and method for generating a tuning frequency.

### BRIEF DESCRIPTION OF THE DRAWINGS

The invention is pointed out with particularity in the appended claims. However, a more complete understanding of the invention may be derived by referring to the detailed description when considered in connection with the figures, wherein like reference numbers refer to similar items throughout the figures and:

FIG. 1 is a functional block diagram of a wideband tuning circuit in accordance with an embodiment of the invention;

FIG. 2 is a functional block diagram of a frequency band module in accordance with an embodiment of the invention;

FIG. 3 illustrates band and sub-band partitioning in accordance with an embodiment of the invention;

FIG. 4 is an example circuit diagram of a tuning sensitivity controller and a sub-band tuning network in accordance with an embodiment of the invention;

FIG. 5 is an example circuit diagram of a negative resistance generator in accordance with an embodiment of the invention; and

FIG. 6 is a flow chart of a tuning frequency generation procedure in accordance with an embodiment of the invention.

### DETAILED DESCRIPTION

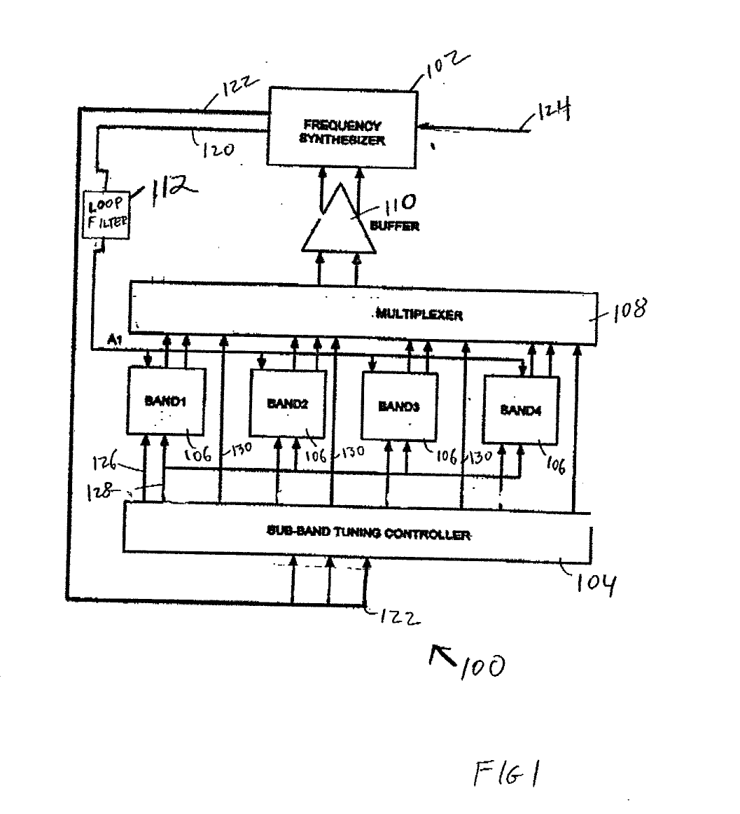

The description set out herein illustrates various embodiments of the invention, and such description is not intended to be construed as limiting in any manner. FIG. 1 is a functional block diagram of a wideband tuning circuit in accordance with an embodiment of the invention. Wideband tuning circuit 100 may comprise frequency synthesizer 102, sub-band tuning controller 104, a plurality of frequency band modules 106, multiplexer 108, and buffer 110. Frequency synthesizer 102 generates tuning sensitivity control signal 120 and sub-band control signals 122 from frequency set command 124. Sub-band tuning controller 104 may generate frequency band module control signals 126, 128 and band select signals 130 in response to sub-band control signals 122. Frequency band modules 106 generate an output frequency in response to frequency band module control signals 126, 128 and tuning sensitivity control signal 120. Multiplexer 108 selectively couples an output frequency from one of frequency band modules 106 to buffer 110 in response to one of band select signals 130. The output frequency generated by frequency band modules 106 may be a differential output frequency selectively coupled by multiplexer 108 to buffer 110. Sub-band control signals 122 may be generated from the frequency set command and may be a combination of digital signals indicating a particular band and sub-band within the tuning frequency range.

The tuning frequency generated by circuit 100 may be within a frequency range that has several frequency bands. Each frequency band module 106 may be configured to generate frequencies within one of the corresponding frequency bands. Frequency band module control signal 126 causes module 106 to select a sub-band within the frequency band of the frequency band module.

The frequency range of the tuning frequency may be at least between 1.2 GHz and 1.95 GHz. Each frequency band module 106 may be configured, for example, to generate at least approximately a 250 MHZ band within the frequency range. Each band may in part overlap with adjacent band and may have two or more sub-bands which also may overlap in part.

Tuning sensitivity control signal 120 tracks and controls the output frequency within the particular sub-band. Tuning sensitivity control signal 120 is generated by the frequency synthesizer and may have a square wave. Loop filter 112 may convert the square wave to a current signal. Frequency synthesizer 102 may include a phase-locked-loop function to adjust tuning sensitivity control signal 120 in response to the output frequency from multiplexer 108. This helps maintain the tuning frequency indicated by frequency set command 124. Tuning sensitivity control signal 120, after filtering, may provide a discrete programmable current source. This helps allows one of frequency band modules 106 to center its output frequency within a particular sub-band. This also helps one of frequency band modules 106 to maintain signal quality across the sub-band.

Frequency synthesizer 102, sub-band tuning controller 104, frequency band modules 106, multiplexer 108 and buffer 110 may be fabricated on a single semiconductor chip with, for example, a low-voltage silicon process. Loop filter 112 may be located externally to the semiconductor chip. A suitable low-voltage silicon process may include, for example, a 0.35 micron complementary metal-oxide semiconductor (CMOS) process having a nominal voltage of approximately between 3 and 4 volts. The various embodiments of the invention are scalable and equally applicable to fabrication with other semiconductor processing techniques and voltages.

Frequency set command 124 may correspond to a channel of a television system, where the tuning frequency may be used to up-convert an input signal, for example, in the range of 50 to 800 MHz. Tuning circuit 100 may be used in, for example, a dual conversion receiver commonly used in cable television system infrastructure, direct broadcast satellite systems, multi-point distribution systems (e.g., wireless LAN) and cable modems. The range of the tuning frequency may be at least between 1.2 GHz and 1.95 GHz. Additional frequency band modules 106 may be included for greater tuning frequency ranges.

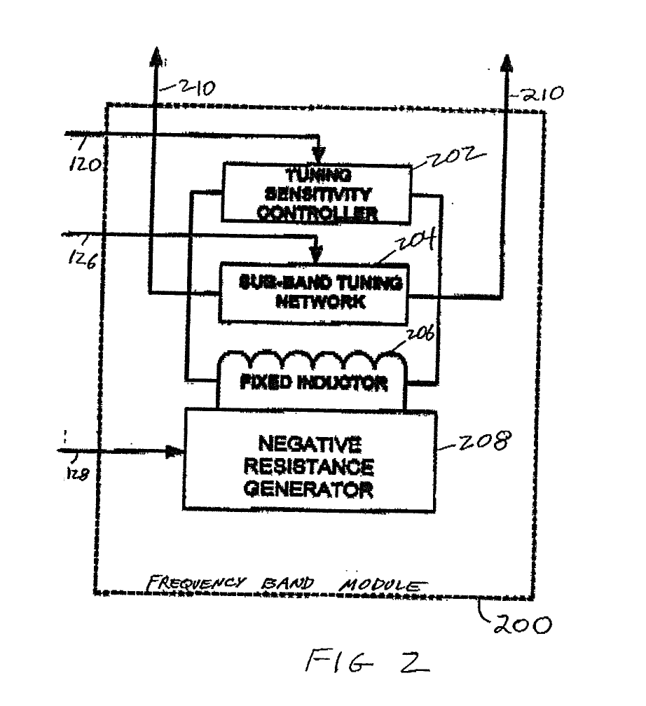

FIG. 2 is a functional block diagram of a frequency band module in accordance with an embodiment of the invention. Frequency band module 200 includes tuning sensitivity controller 202, sub-band tuning network 204, resonator inductor 206 and negative resistance generator 208, which in combination, may generate differential output signal 210 at the tuning frequency. Frequency band module 200 may be suitable for use as one of frequency band modules 106 (FIG. 1). Tuning sensitivity controller 202 may be responsive to tuning sensitivity 4: control signal 120 (FIG. 1), sub-band tuning network 204 may be responsive to frequency band module control signal 126 (FIG. 1), and negative resistance generator 208 may be responsive to frequency band module control signals 128 (FIG. 1).

Negative resistance generator 208 functions to offset the resistance of inductor 206. The type of signal output comprising output signal 210 may depend on whether or not negative resistance generator 208 is activated by control signal 128. For example, when negative resistance generator is activated, a continuous wave (CW) output signal may be generated. When negative resistance generator is not activated, a DC output signal may be produced.

Each frequency band module 200 may be designed specifically for a particular frequency band. In this embodiment, the circuit elements of tuning sensitivity controller 202 and sub-band tuning network 204 may have their component values selected for the particular frequency band. Negative resistance generator 208 and inductor 206 may be the same for each frequency band. Tuning sensitivity controller 202 and sub-band tuning network 204 may have transistors, such as CMOS field-effect transistors (FETs), to provide capacitance responsive to tuning sensitivity control signal 120 and frequency band module control signal 126 respectively. Frequency band module control signal 126 controls the selection of a particular sub-band within the frequency band of module 200. A sensitivity in the range of 45 MHz per volt may be achieved through sub-band partitioning.

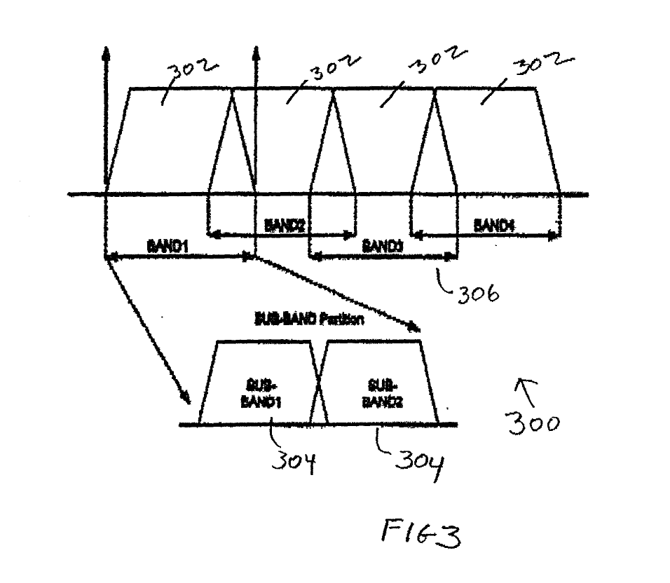

FIG. 3 illustrates band and sub-band partitioning in accordance with an embodiment of the invention. Tuning frequency range 300 may have a plurality of frequency bands 302. Each frequency band 302 may have one or more sub-bands 304. Each frequency band module 200 may generate tuning frequencies in the range of one of frequency bands 302. A particular sub-band 304 within a frequency module's band may be selected, for example, through the use of sub-band tuning network 204 (FIG. 2) to help improve tuning sensitivity across the band. Each band 302 overlap 306 in frequency with adjacent bands 302.

Frequency range 300 may be at least between 1.2 GHz and 1.95 GHz. In this embodiment, there may be four bands 302 each having two sub-bands 304. Each band 302, for example, may be approximately 250 MHz wide, and each sub-band 304, for example, may be approximately 125 MHz wide. An overlap of between 50 and 60 MHz, for example, may be provided between bands 302. The invention is equally suitable to other tuning frequency ranges and configurations having a different number of bands 302 and sub-bands 304.

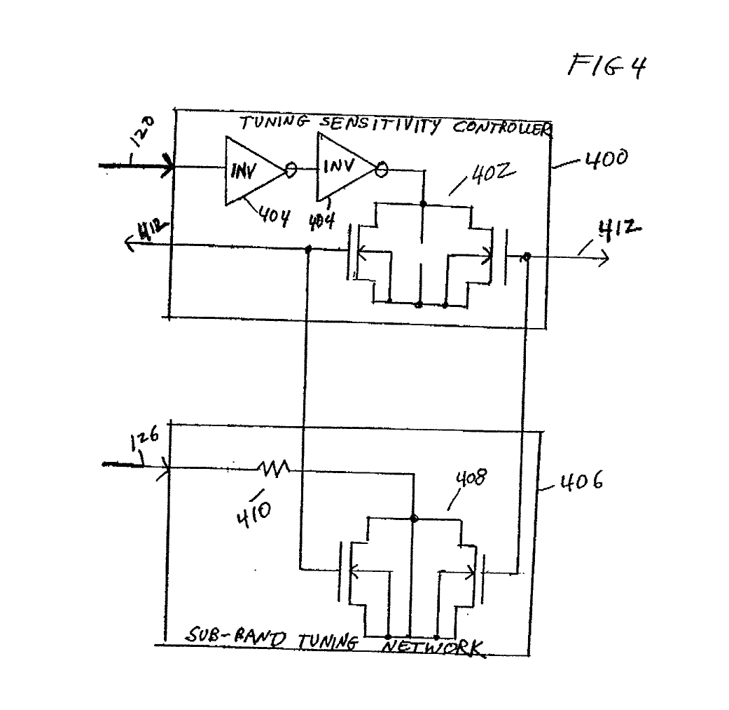

FIG. 4 is an example circuit diagram of a tuning sensitivity controller and sub-band tuning network in accordance with an embodiment of the invention. Tuning sensitivity controller 400 may have transistors 402 and inverters 404. Sub-band tuning network 406 may have transistors 408 and resistive element 410. Tuning sensitivity controller 400 and sub-band tuning network 406 may be suitable for tuning sensitivity controller 202 (FIG. 2) and sub-band tuning network 204 (FIG. 2) respectively.

The dimensions (e.g., gate width, length, number of gate fingers, etc.) of the transistors may be determined based on the desired capacitance for a particular band and sub-band, and may depend on the value of inductor 206 (FIG. 2) and the semiconductor process characteristics. The elements of tuning sensitivity controller 400 and sub-band tuning network 406 may be specifically designed for a particular band and sub-band.

Tuning sensitivity controller 400 and sub-band tuning network 406 provide capacitance responsive to tuning sensitivity control signal 120 and frequency band module control signal 126 respectively. Frequency band module control signal 126 may be a digital signal to enable a particular sub-band with the frequency band of module 200 (FIG. 2). Tuning sensitivity control signal 120 tracks the desired frequency within the enabled sub-band. Tuning sensitivity controller 404 and sub-band tuning network 406 have outputs 412 which may be coupled to outputs 210 (FIG. 2) of module 200 (FIG. 2)

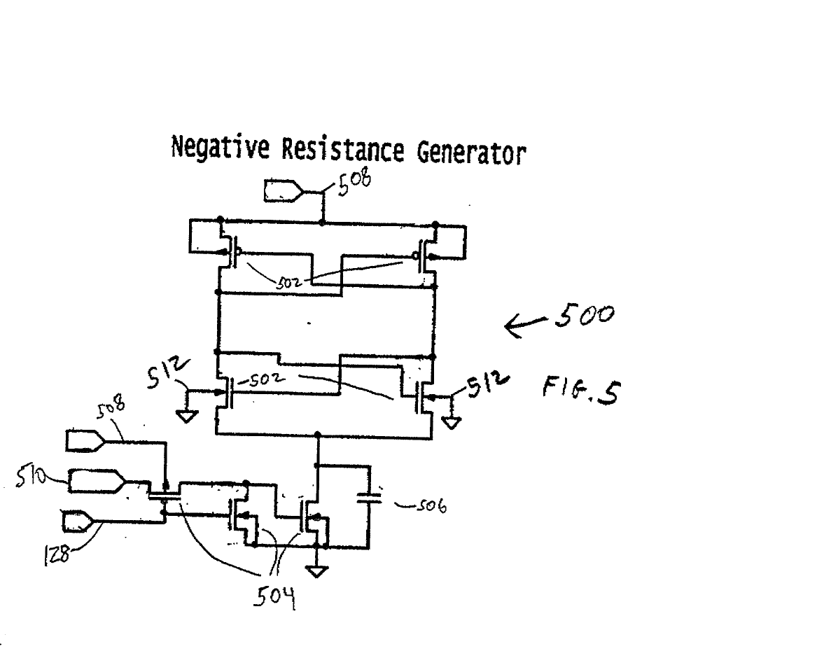

FIG. 5 is an example circuit diagram of a negative resistance generator in accordance with an embodiment of the invention. Negative resistance generator 500 may have pairs 502 of cross-coupled transistors, transistors 504, and capacitor 506. Generator 500 receives supply voltage 508 and may be enabled by control signal 128. Negative resistance generator 500 may be suitable for use as negative resistance generator 208 (FIG. 2). Input 510 may be a control voltage, and may be 1.35 volts depending on the process used to fabricate generator 500. Generator 500 has outputs 512 coupled to outputs 210 (FIG. 2) of frequency band module 200 (FIG. 2).

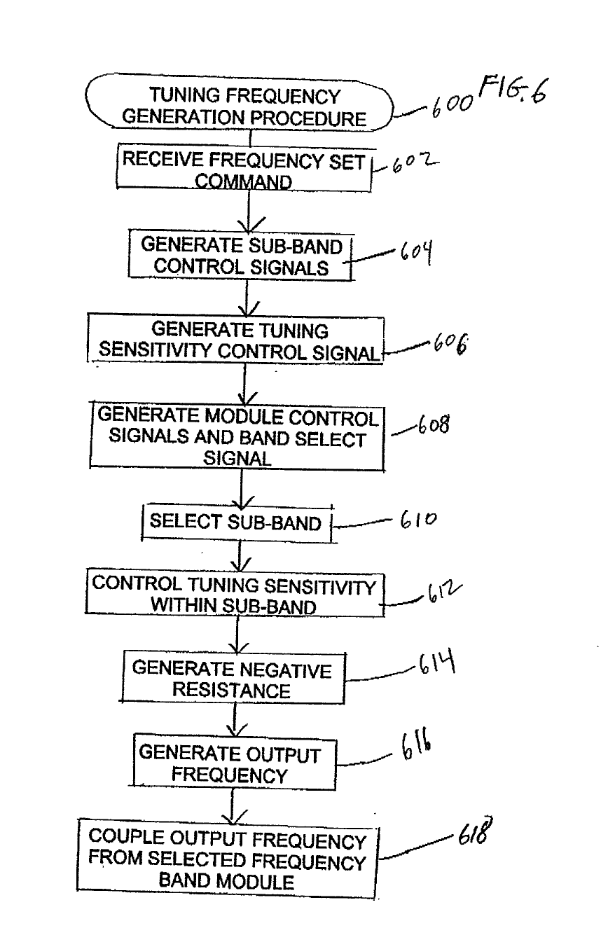

FIG. 6 is a flow chart of a tuning frequency generation procedure in accordance with an embodiment of the invention. Although the individual operations of procedure 600 are illustrated and described as separate operations, one or more of the individual operations may be performed concurrently. Further, the operations need not be performed in the order illustrated. Procedure 600 may be performed by wideband tuning circuit 100 (FIG. 1), although other tuning circuits may also be suitable for performing procedure 600.

Operation 602 receives a frequency set command to indicate a tuning frequency to generate. The frequency set command may be a digital signal received from a system controller such as, for example, a cable system head-end, a local television controller or other external source. The frequency set command may be provided from a register and may be similar to frequency set command 124 (FIG. 1).

Operation 604 generates sub-band control signals from the frequency set command. Sub-band control signals may be a combination of digital signals indicating a particular band and sub-band within the tuning frequency range and may be similar to control signals 122 (FIG. 1).

Operation 606 generates a tuning sensitivity control signal. The tuning sensitivity control signal may be used to track and control the output frequency within the sub-band, and may be similar to control signal 120 (FIG. 1). Operations 602 through 606, for example, may be performed by frequency synthesizer 102 (FIG. 1).

Operation 608 generates module control signals and a band select signal. One of the module control signals may select a particular sub-band of a frequency band module and may be similar to control signal 126 (FIG. 1). Another of the module control signal may activate or deactivate a negative resistance generator of a frequency band module and may be similar to control signal 128 (FIG. 1). The band select signal may cause a multiplexer to select the output of a particular frequency band module and may be similar to control signals 130 (FIG. 1). Operation 608 may generate the module control signals and the band select signal from sub-band control signals generated in operation 604. Operation 608, for example, may be performed by sub-band tuning controller 104 (FIG. 1).

Operation 610 selects a particular sub-band based on the module control signals generated in operation 608. Operation 610 may be performed, for example, by sub-band tuning network 204 (FIG. 2). Operation 612 controls tuning sensitivity within a particular sub-band using the tuning sensitivity control signal generated in operation 606. Operation 612 may be performed, for example, by tuning sensitivity controller 202 (FIG. 2). Operation 614 generates a negative resistance. The negative resistance may be generated in response to a module control signal generated in operation 608. The negative resistance may compensate, at least in part, for resistance of a resonating inductor used in generating the tuning frequency. Operation 614 may be performed, for example, by negative resistance generator 208 (FIG. 2).

Operation 616 generates an output frequency in response to operations 610 through 614. Operation 618 selectively couples the output frequency to provide the tuning frequency. Operation 618 may be performed by a multiplexer responsive to the band select signal generated in operation 608. Operation 618 may be performed, for example, by multiplexer 108 (FIG. 1). Operations 612 through 616, for example, may be performed by one of frequency band modules 106 (FIG. 1).

Thus, an improved wideband tuning circuit and method for generating a tuning frequency have been described. In one embodiment, a wideband tuning circuit for generating a tuning frequency may be suitable for fabrication on a semiconductor chip, for example, with a low voltage semiconductor process. The wideband tuning circuit and method of the invention may generate a tuning frequency without the use of high-voltage, high-capacitance ratio varactors and without the need for a separate power supply as with many conventional tuning modules. In at least one embodiment, a wideband tuning frequency is generated without high-voltage, high-capacitance ratio varactors and without the need for a separate power supply as required by many conventional tuning modules. In one embodiment, a wideband tuning circuit suitable for fabrication using a low-voltage silicon process includes a plurality of frequency band modules for generating a frequency within a particular frequency band of the tuning range. In this embodiment, each frequency band module may include a tuning sensitivity controller responsive to a tuning sensitivity control signal, a sub-band tuning network responsive to frequency band module control signals, a resonator inductor, and a negative resistance generator coupled to the inductor to offset resistance of the inductor. The frequency band module control signal may cause the sub-band tuning network to select a sub-band within the frequency band of the frequency band module. The tuning sensitivity control signal may cause the tuning sensitivity controller to control the output frequency of the frequency band module within the selected sub-band. A multiplexer may selectively couple the output frequency from one of the frequency band modules in response to a band select signal.

The foregoing description of specific embodiments reveals the general nature of the invention sufficiently that others can, by applying current knowledge, readily modify and/or adapt it for various applications without departing from the generic concept. Therefore such adaptations and modifications are intended to be comprehended within the meaning and range of equivalents of the disclosed embodiments. The phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A wideband tuning circuit for generating a tuning frequency comprising:
a plurality of frequency band modules, each module configured generate an output frequency within a frequency band,
wherein each frequency band module comprises:
a sub-band tuning network responsive to a frequency band module control signal to select a sub-band within the frequency band of the module; and
a tuning sensitivity controller responsive to a tuning sensitivity control signal to maintain a tuning sensitivity across the selected sub-band.

2. The wideband tuning module of claim 1 wherein the sub-band tuning network has capacitance controllable by the frequency band module control signal to select a sub-band within the frequency band of the module, and the tuning sensitivity controller has capacitance controllable by the tuning sensitivity control signal to maintain a tuning sensitivity across the selected sub-band.

3. The wideband tuning module of claim 2 wherein the sub-band tuning network and the tuning sensitivity controller are comprised of CMOS transistors fabricated on a single semiconductor chip with a low-voltage silicon process.

4. The wideband tuning module of claim 1 farther comprising a multiplexer to selectively couple the output frequency from one of the frequency band modules in response to a band select signal to provide the tuning frequency, and
wherein each frequency band module further comprises:
a resonator inductor; and
a negative resistance generator coupled to the inductor to offset resistance of the inductor in response to another of the frequency band module control signals.

5. A wideband tuning circuit to generate a tuning frequency comprising:
a plurality of frequency band modules to generate an output frequency in response to frequency band module control signals and a tuning sensitivity control signal, the tuning sensitivity control signal being controlled to maintain a tuning sensitivity across a selected sub-band of one of the frequency band modules; and
a multiplexer to selectively couple the output frequency from one of the frequency band modules in response to a band select signal.

6. The circuit of claim 5 wherein at least one of the frequency band modules comprises:
a tuning sensitivity controller responsive to the tuning sensitivity control signal;
a sub-band tuning network responsive to one of the frequency band module control signals;
a resonator inductor; and
a negative resistance generator coupled to the inductor to offset resistance of the inductor in response to another of the frequency band module control signals.

7. The circuit of claim 6 wherein the tuning sensitivity controller and the sub-band tuning network are comprised of CMOS transistors to provide capacitance responsive to the tuning sensitivity control signal and to one of the frequency band module control signals respectively.

8. The circuit of claim 6 wherein the tuning frequency is within a frequency range comprised of a plurality of frequency bands, each frequency band module configured to generate frequencies within a corresponding one of the frequency bands, and wherein the one of the frequency band module control signals causes the sub-band tuning network to select a sub-band within the frequency band of the frequency band module.

9. The circuit of claim 8 wherein the tuning sensitivity control signal causes the tuning sensitivity controller to control the output frequency of the frequency band module within the selected sub-band.

10. The circuit of claim 5 further comprising:
a frequency synthesizer to generate the tuning sensitivity control signal and the sub-band control signals from a frequency set command; and
a sub-band tuning controller to generate the frequency band module control signals and the band select signal in response to the sub-band control signals.

11. The circuit of claim 1 0 wherein the frequency synthesizer, the sub-band tuning controller, the plurality of frequency band modules and the multiplexer are fabricated on a single semiconductor chip with a low-voltage silicon process.

12. The circuit of claim 11 wherein the low-voltage process is a 0.35 micron CMOS process having a nominal voltage of approximately between 3 and 4 volts.

13. The circuit of claim 11 wherein the tuning sensitivity control signal generated by the frequency synthesizer is comprised of a square wave, and wherein a loop filter converts the square wave to a current, the loop filter being located external to the semiconductor chip.

14. The circuit of claim 10 wherein the frequency synthesizer includes a phase locked loop function to adjust the tuning sensitivity control signal in response to the output frequency from the multiplexer to maintain the tuning frequency indicated by the frequency set command.

15. The circuit of claim 10 further comprising a buffer coupled between the multiplexer and the frequency synthesizer to receive the output frequency from the multiplexer and provide the output frequency to the frequency synthesizer, the output of the buffer being the tuning frequency.

16. The circuit of claim 5 wherein the output frequency generated by one of the frequency band modules is a differential output frequency.

17. The circuit of claim 5 wherein a frequency set command corresponds with a channel of a television system, and wherein the tuning frequency up-converts a input signal in the range of 50 to 800 MHz.

18. The circuit of claim 17 wherein a frequency range of the tuning frequency is at least between 1.2 GHz and 1.95 GHz, and each frequency band module is configured to generate approximately a 250 MHZ portion of the frequency range, and wherein one of the frequency band module control signals causes the frequency band module to select a sub-band within the frequency band of the module.

19. A method for generating a wideband tuning signal comprising:
generating a tuning sensitivity control signal; and
generating frequency band module control signals to activate one of a plurality of frequency band modules;
wherein the frequency band module control signal controls capacitance of a sub-band tuning network to select a sub-band within the frequency band of the module, and
wherein the tuning sensitivity control signal controls capacitance of a tuning sensitivity controller to maintain a tuning sensitivity across the selected sub-band to maintain a frequency of the wideband tuning signal indicated by a frequency set command.

20. The method of claim 19 further comprising selectively multiplexing an output of one of the frequency band modules to provide a tuning signal output.

21. The method of claim 20 further comprising generating a control signal to activate a negative resistance generator to offset a resistance of a resonator inductor coupled to the tuning sensitivity controller and the sub-band tuning network.

22. The method of claim 21 wherein the sub-band tuning network and the tuning sensitivity controller are comprised of CMOS transistors fabricated on a single semiconductor chip with a low-voltage silicon process.
